(19) United States
(12) Patent Application Publication
(10) Pub. No.: US 2010/0059698 A1
(43) Pub. Date: Mar. 11, 2010

(54) SOLENOID VALVE

(76) Inventors: Harald Guggenmos, Immenstadt/Seifen (DE); Florian Rispler, Hirschegg (AT); Christoph Kasper, Charleston, SC (US); Guenther Schnalzger, Blaichach (DE); Martin Kirschner, Blaichach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/515,178

(22) PCT Filed: Sep. 26, 2007
(86) PCT No.: PCT/EP07/60217

§ 371 Date: May 15, 2009

(30) Foreign Application Priority Data
Nov. 16, 2006 (DE) 1020006054184.7

(51) Int. Cl. F16K 31/06

(52) U.S. Cl. 251/129.15

(57) ABSTRACT

The invention relates to a solenoid valve having a magnetic assembly and a valve cartridge. The valve cartridge includes a capsule, a valve insert connected to the capsule and an armature that is mobile in the capsule. The armature includes a tappet having a first closing element. A magnetic force produced by the magnetic assembly displaces the armature towards the valve insert. As a result, the first closing element sealingly plunges into a main valve seat. The invention is provided with a valve sleeve which is placed on the valve insert in which the main valve seat is formed.

### PRIOR ART

The invention relates to a solenoid valve according to the preamble to the independent claim 1.

A conventional solenoid valve, in particular for a hydraulic unit that is used for example in an antilock brake system (ABS), a traction control system (TCS), or an electronic stability program system (ESP system) is shown in FIG. 1. As is clear from FIG. 1, the conventional solenoid valve 1, which is open in the currentless state, includes a magnet assembly 2 for producing a magnetic flux—which includes a housing casing 3, a winding holder 4, a coil winding 5, and a covering disk 6—and a valve cartridge 10—which includes a capsule 11, a valve insert 12 embodied for example in the form of a cold-forged part, an armature 13 with a tappet 14, and a return spring 15. The magnet assembly 2 produces a magnetic force that moves the longitudinally movable armature 13 with the tappet 14 toward the valve seat 12 in opposition to the force of the return spring 15. The coil winding 5 wound onto the winding holder 4 is an electrical coil that can be activated via electrical connections 7. The magnetic flux that the magnet assembly 2 has introduced via the covering disk 6 is conducted by the valve insert 12 axially toward the armature 13 via an air gap 8. Through the supply of current to the coil winding 5 via the electrical connections 7 and the magnetic flux that this produces, the armature 13 is moved toward the valve insert 12 in opposition to the force of the return spring 15. In addition, the valve insert 12 accommodates a precisely embodied valve member 16 that includes a main valve seat 17 into which the tappet 14 travels in a sealed fashion with a first closing element 14.1 embodied in the form of a sealing dome in order to perform the sealing function of the solenoid valve 1. As is also clear from FIG. 1, the valve member 16 embodied in the form of a steel part, for example, has a lower valve part 20 made of plastic inserted into it, which has a valve seat 21 of a check valve that performs a directional flow function. The lower valve part 20 performs the functions of both guiding a second closing element 22 for the check valve and producing a seal 24 in relation to the fluid assembly 19 into which the solenoid valve 1 is caulk-mounted by means of a caulking flange 18 situated on the valve insert 12. The stroke of the second closing element 22 is limited by a stroke limiter 23 or assembly, which is inserted into the lower valve part 20.

### DISCLOSURE OF THE INVENTION

The solenoid valve according to the invention, with the defining characteristics of the independent claim 1, has the advantage over the prior art that a valve sleeve has a main valve seat and is slid onto a valve insert. It is advantageously possible for the valve sleeve to be manufactured using the inexpensive deep-drawing technique and for the actual valve seat to be formed into the deep-drawn part by means of a shaping procedure such as stamping. The valve sleeve with the main valve seat is part of a valve cartridge of the solenoid valve according to the invention, which also includes, for example, a capsule that is attached to the valve insert and includes an armature supported inside the capsule in moving fashion, which in turn includes a tappet with a first closing element. The solenoid valve according to the invention also includes a magnet assembly, which produces a magnetic force that moves the armature toward the valve insert, causing the first closing element to travel into the main valve seat in a sealed fashion, thus closing the latter.

Advantageous improvements of the solenoid valve disclosed in the independent claim 1 are possible by means of the steps taken and modifications made in the dependent claims.

It is particularly advantageous that the valve sleeve also includes a check valve seat that can likewise be formed by means of a shaping procedure such as stamping into the valve sleeve embodied in the form of a deep-drawn part. In order to close or open the check valve seat, a second closing element is provided, which closes or opens the check valve seat as a function of the flow direction of a volumetric flow. The stroke of the second closing element is limited, for example, by a first filter, which is situated beneath the valve sleeve and is embodied as a flat filter, for example.

In one embodiment of the solenoid valve according to the invention, a first volumetric flow pushes the second closing element into the check valve seat in a sealed fashion, with the first volumetric flow being regulated by the first closing element that cooperates with the main valve seat. A second volumetric flow, which flows in the opposite direction from the first volumetric flow, pushes the second closing element out of the check valve seat, against the first filter, and opens the check valve seat. The second volumetric flow is filtered, for example, by a second filter that is embodied in the form of a radial filter, for example.

In another embodiment of the solenoid valve according to the invention, the valve insert is embodied as slotted in order to advantageously permit an optimized flow guidance of the volumetric flows.

In order to attach the solenoid valve according to the invention to a fluid assembly, the valve cartridge is caulk-mounted, for example, to a caulking region in the fluid assembly by means of a caulking flange formed onto the valve insert; the valve sleeve is sealed against the fluid assembly by means of a press-fit and serves to divide the fluid circuits.

Both the conventional exemplary embodiment described above for the sake of better comprehension and advantageous embodiments of the invention described below are shown in the drawings. Components and elements that perform the same or analogous functions are provided with the same reference numerals in the drawings.

### BRIEF DESCRIPTION OF THE DRAWINGS

FIG. 1 is a schematic, sectional depiction of a conventional solenoid valve.

FIG. 2 is a schematic, sectional depiction of a valve cartridge of a solenoid valve according to the invention.

FIG. 3 is a front view of a valve insert of the solenoid valve according to the invention shown in FIG. 2.

### EMBODIMENTS OF THE INVENTION

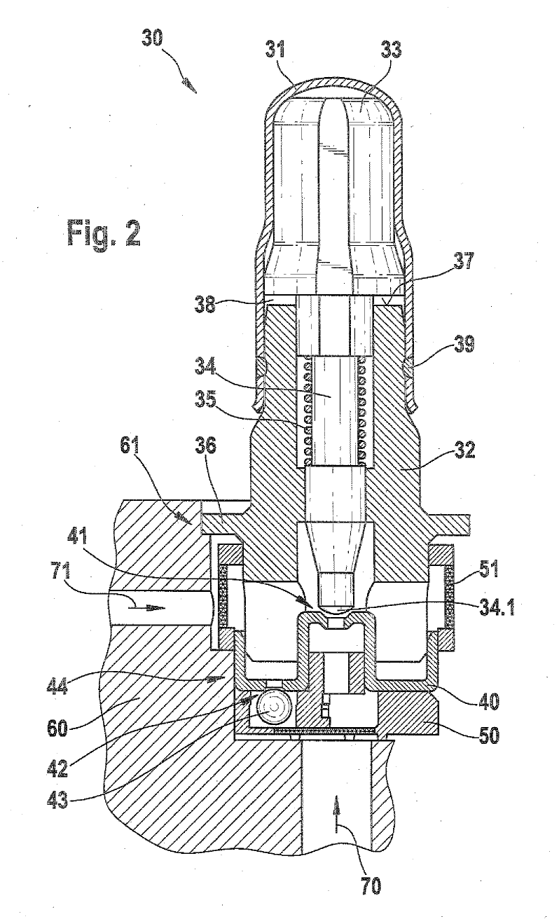

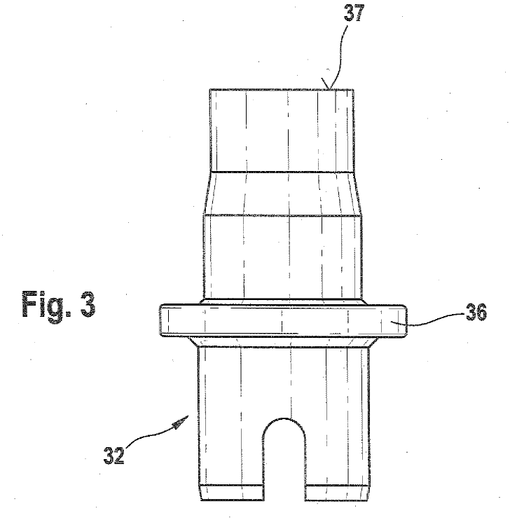

As is clear from FIGS. 2 and 3, a valve cartridge 30 for a solenoid valve according to the invention, for example a solenoid valve that is closed in the currentless state, includes a capsule 31, a slotted valve insert 32, an armature 33 with a tappet 34 and a first closing element 34.1, a return spring 35, and a valve sleeve 40 equipped with a main valve seat 41 and a check valve seat 42. The valve sleeve 40 is embodied, for example, as a deep-drawn part into which the main valve seat 41 and check valve seat 42 are formed by means of a shaping procedure such as stamping. The capsule 31 in which the armature 33 is guided in a longitudinally movable fashion, is slid onto the valve insert 32 and fastened to the slotted valve insert 32 by means of a seal weld 39, for example a laser-welded seam. The seal weld 39 also serves as the seal in relation to the outside. A magnetic force produced by a magnet assembly not shown in the drawing and a magnetic flux guided via an air gap 38 pull the armature 33 axially toward a pole surface 37 of the valve insert 32 in opposition to the force of the return spring 35. As a result of this movement, the end of the tappet 34 embodied as the first closing element 34.1 is slid into the main valve seat 41 of the valve sleeve 40, thus making it possible to regulate a first volumetric flow 70 that pushes from beneath against the first closing element 34.1, which is embodied for example in the form of a sealing dome. The return spring 35 holds the main valve seat 41 open in the currentless state.

In order to produce a larger through-flow area, the valve sleeve 40 has a check valve with a check valve seat 42 provided in it, which a second closing element 43 embodied, for example, in the form of a sealing ball can open and close as a function of the flow direction of the volumetric flow. Consequently, the check valve performs a directional flow function. In the exemplary embodiment shown, the second closing element 43 closes the check valve seat 42 in the presence of the first volumetric flow 70 and opens the check valve 42 in the presence of the second volumetric flow 71, which has a flow direction opposite from the flow direction of the first volumetric flow 70. In addition, the stroke of the second closing element 43 is limited by a first filter 50, which is embodied, for example, in the form of a flat filter and also fixes the position of the second closing element 43. The first filter 50, which is embodied in the form of a flat filter, filters the first volumetric flow 70 and a second filter 51, which is embodied for example in the form of a radial filter, filters the second volumetric flow 71.

As is clear from FIG. 2, the valve cartridge 30 of the solenoid valve according to the invention is caulk-mounted to a caulking region 61 in the fluid assembly 60 by means of a caulking flange 36 formed onto the valve insert 32; the valve sleeve 40 is sealed against the fluid assembly 60 by means of a press-fit 44 and serves to divide the fluid circuits.

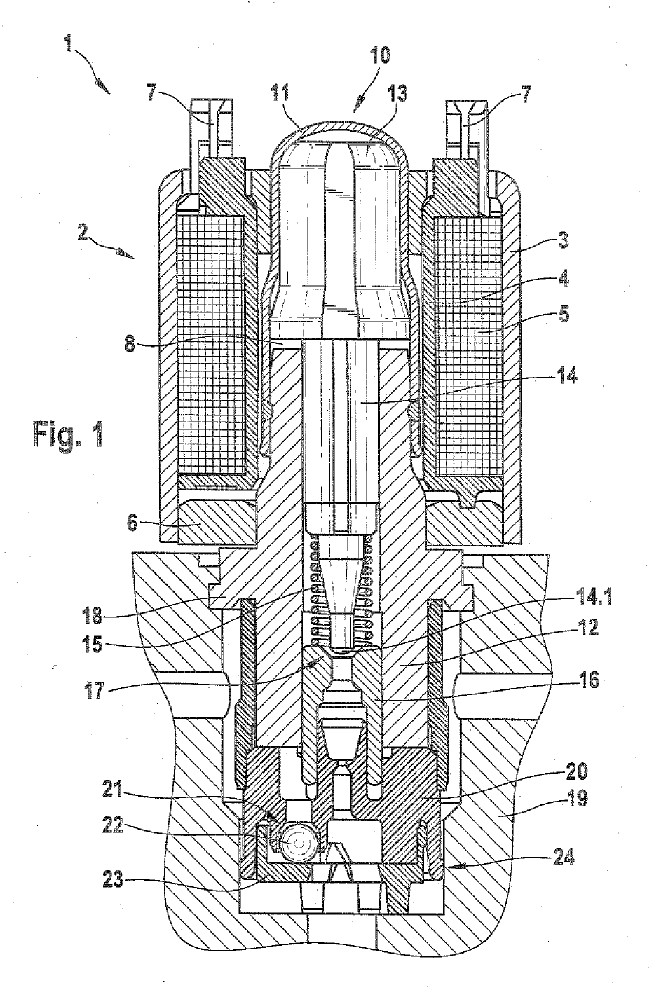

The magnet assembly, not shown, which produces the magnetic force and magnetic flux in order to move the armature 33 toward the pole surface 37 of the valve insert 32 when it is supplied with current, can be embodied analogously to the magnet assembly 2 shown in FIG. 1 and can include a housing casing 3, a winding holder 4, a coil winding 5, and a covering disk 6; the coil winding 5 wound onto the winding holder 4 is an electrical coil that can be activated via electrical connections 7.

The solenoid valve according to the invention advantageously has a smaller number of components, which, by contrast with plastic parts, are less susceptible to fluctuations in temperature and moisture and do not have a tendency to swell. Both the main valve seat and the check valve seat can be stamped into the valve sleeve according to the invention. In addition, the valve sleeve according to the invention, which is manufactured for example in the form of a deep-drawn part, makes it possible to provide an inexpensive precision part that has no noncircularities in the seat region of the kind that can result from warpage during the injection molding process used for the precision injection molded part known from the prior art.

The solenoid valve according to the invention can be used, for example, in fluid assemblies that are used in an antilock brake system (ABS), a traction control system (TCS), or an electronic stability program system (ESP system).

1-10. (canceled)

11. A solenoid valve with a magnet assembly and a valve cartridge, the valve cartridge including a capsule, a valve insert connected to the capsule, and an armature which is situated in a movable fashion inside the capsule and which includes a tappet equipped with a first closing element, a magnetic force being produced by the magnet assembly which causes the armature to move toward the valve seat, as a result of which the first closing element travels into a main valve seat in a sealed fashion, wherein a valve sleeve, which includes the main valve seat, is slid onto the valve insert.

12. The solenoid valve as recited in claim 11, wherein the valve sleeve includes a check valve seat.

13. The solenoid valve as recited in claim 12, wherein the valve sleeve is manufactured as a deep-drawn part into which the main valve seat and the check valve seat are formed by means of a shaping procedure.

14. The solenoid valve as recited in claim 12, having a second closing element that closes or opens the check valve seat as a function of a flow direction of a volumetric flow.

15. The solenoid valve as recited in claim 13, having a second closing element that closes or opens the check valve seat as a function of a flow direction of a volumetric flow.

16. The solenoid valve as recited in claim 14, wherein a stroke of the second closing element is limited by a first filter situated beneath the valve sleeve.

17. The solenoid valve as recited in claim 15, wherein a stroke of the second closing element is limited by a first filter situated beneath the valve sleeve.

18. The solenoid valve as recited in claim 14, wherein a first volumetric flow, which is regulated by the first closing element, pushes the second closing element against the check valve seat in a sealed fashion.

19. The solenoid valve as recited in claim 15, wherein a first volumetric flow, which is regulated by the first closing element, pushes the second closing element against the check valve seat in a sealed fashion.

20. The solenoid valve as recited in claim 16, wherein a first volumetric flow, which is regulated by the first closing element, pushes the second closing element against the check valve seat in a sealed fashion.

21. The solenoid valve as recited in claim 17, wherein a first volumetric flow, which is regulated by the first closing element, pushes the second closing element against the check valve seat in a sealed fashion.

22. The solenoid valve as recited in claim 14, wherein a second volumetric flow pushes the second closing element out of the check valve seat against the first filter and opens the check valve seat.

23. The solenoid valve as recited in claim 16, wherein a second volumetric flow pushes the second closing element out of the check valve seat against the first filter and opens the check valve seat.

24. The solenoid valve as recited in claim 18, wherein a second volumetric flow pushes the second closing element out of the check valve seat against the first filter and opens the check valve seat.

25. The solenoid valve as recited in claim 22, wherein the second volumetric flow is filtered by a second filter.

26. The solenoid valve as recited in claim 23, wherein the second volumetric flow is filtered by a second filter.

27. The solenoid valve as recited in claim 24, wherein the second volumetric flow is filtered by a second filter.

28. The solenoid valve as recited in claim 11, wherein the valve insert is embodied in a slotted form.

29. The solenoid valve as recited in claim 11, wherein the valve cartridge is caulk-mounted to a caulking region in a fluid assembly by means of a caulking flange, which is formed onto the valve insert, and the valve sleeve is sealed against the fluid assembly (60) by means of a press-fit.

30. The solenoid valve as recited in claim 12, wherein the valve cartridge is caulk-mounted to a caulking region in a fluid assembly by means of a caulking flange, which is formed onto the valve insert, and the valve sleeve is sealed against the fluid assembly (60) by means of a press-fit.
